(19) United States
(12) Patent Application Publication
(10) Pub. No.: US 2013/0150802 A1
(43) Pub. Date: Jun. 13, 2013

(54) CODED CAP FOR USE WITH A DRUG DELIVERY DEVICE

(71) Applicant: Timothy Giles Claughton, Congleton (GB)

(72) Inventor: Timothy Giles Claughton, Congleton (GB)

(73) Assignee: SANOFI-AVENTIS DEUTSCHLAND GMBH, Frankfurt am Main (DE)

(21) Appl. No.: 13/639,420

(22) PCT Filed: Apr. 7, 2011
(86) PCT No.: PCT/EP2011/055397

§ 371 Date: Feb. 19, 2013

Related U.S. Application Data
(60) Provisional application No. 61/322,698, filed on Apr. 9, 2010.

(30) Foreign Application Priority Data
Jul. 29, 2010 (EP) 10171162.0

(51) Int. Cl. A61M 5/32

(52) U.S. Cl. CPC B67D 99/00
USPC 604/198

(57) ABSTRACT

A cap-fit differentiation means for use with a medication or drug delivery device is described. The cap includes at least one first coding feature located on a surface of the cap, the at least one coding feature configured to interact with at least one second coding feature located on the drug delivery device. When the first and second coding features interact, feedback is provided to a user. The feedback may include tactile and/or audible feedback. The second coding feature may alternatively be located on the cartridge or cartridge holder.

### CROSS REFERENCE TO RELATED APPLICATIONS

The present application is a U.S. National Phase Application pursuant to 35 U.S.C. §371 of International Application No. PCT/EP2011/055397 filed Apr. 7, 2011, which claims priority to U.S. Provisional Patent Application No. 61/322,698 filed Apr. 9, 2010 and European Application No. 10171162.0 filed Jul. 29, 2010. The entire disclosure contents of these applications are herewith incorporated by reference into the present application.

### FIELD OF INVENTION

The present disclosure is generally directed to reservoirs, for example reservoirs containing a medicament. As just one example, such medicament reservoirs may comprise an ampoule, a cartridge, a cartridge assembly, a vial, or a pouch, and may be used with a medical delivery device. The reservoir may be used together with a reservoir housing within a medical delivery device. More particularly, the present application is generally directed to a cap. The cap may be configured to be detachably secured to the reservoir or the reservoir housing or another part of the medical delivery device in order to cover and protect parts of the reservoir, the reservoir housing or the device, especially any openings for delivering a medication or drug to the outside of the reservoir. Exemplary medical delivery devices include, but are not limited to pen-type injection devices, syringes, pen type syringes, pumps, inhalers, or other similar injection or infusing devices that require at least one reservoir containing at least one medicament.

### BACKGROUND

Medicament reservoirs such as ampoules, cartridges, cartridge assemblies, or vials are generally known. Such reservoirs are especially used for medicaments that may be self administered by a patient.

The term “drug” or “medicament”, as used herein, preferably means a pharmaceutical formulation containing at least one pharmaceutically active compound,

wherein in one embodiment the pharmaceutically active compound has a molecular weight up to 1500 Da and/or is a peptide, a proteine, a polysaccharide, a vaccine, a DNA, a RNA, an enzyme, an antibody, a hormone or an oligonucleotide, or a mixture of the above-mentioned pharmaceutically active compound,

wherein in a further embodiment the pharmaceutically active compound is useful for the treatment and/or prophylaxis of diabetes mellitus or complications associated with diabetes mellitus such as diabetic retinopathy, thromboembolism disorders such as deep vein or pulmonary thromboembolism, acute coronary syndrome (ACS), angina, myocardial infarction, cancer, macular degeneration, inflammation, hay fever, atherosclerosis and/or rheumatoid arthritis,

wherein in a further embodiment the pharmaceutically active compound comprises at least one peptide for the treatment and/or prophylaxis of diabetes mellitus or complications associated with diabetes mellitus such as diabetic retinopathy,

wherein in a further embodiment the pharmaceutically active compound comprises at least one human insulin or a human insulin analogue or derivative, glucagon-like peptide (GLP-1) or an analogue or derivative thereof, or exedin-3 or exedin-4 or an analogue or derivative of exedin-3 or exedin-4.

Insulin analogues are for example Gly(A21), Arg(B31), Arg(B32) human insulin; Lys(B3), Glu(B29) human insulin; Lys(B28), Pro(B29) human insulin; Asp(B28) human insulin; human insulin, wherein proline in position B28 is replaced by Asp, Lys, Leu, Val or Ala and wherein in position B29 Lys may be replaced by Pro; Ala(B26) human insulin; Des(B28-B30) human insulin; Des(B27) human insulin and Des(B30) human insulin.

Insulin derivates are for example B29-N-myristoyl-des(B30) human insulin; B29-N-palmitoyl-des(B30) human insulin; B29-N-myristoyl human insulin; B29-N-palmitoyl human insulin; B28-N-myristoyl LysB28ProB29 human insulin; B28-N-palmitoyl-LysB28ProB29 human insulin; B30-N-myristoyl-ThrB29LysB30 human insulin; B30-N-palmitoyl-ThrB29LysB30 human insulin; B29-N-(N-palmitoyl-Y-glutamyl)-des(B30) human insulin; B29-N-(N-lithocholyl-Y-glutamyl)-des(B30) human insulin; B29-N-(ω-carboxyheptadecanoyl)-des(B30) human insulin and B29-N-(ω-carboxyhepta-decanoyl) human insulin.

Exendin-4 for example means Exendin-4(1-39), a peptide of the sequence H His-Gly-Glu-Gly-Thr-Phe-Thr-Ser-Asp-Leu-Ser-Lys-Gln-Met-Glu-Glu-Glu-Ala-Val-Arg-Leu-Phe-Ile-Glu-Trp-Leu-Lys-Asn-Gly-Gly-Pro-Ser-Ser-Gly-Ala-Pro-Pro-Pro-Ser-NH2.

Exendin-4 derivatives are for example selected from the following list of compounds:
H-(Lys)4-des Pro36, des Pro37 Exendin-4(1-39)-NH2,
H-(Lys)5-des Pro36, des Pro37 Exendin-4(1-39)-NH2,
des Pro36 [Asp28] Exendin-4(1-39),
des Pro36 [IsoAsp28] Exendin-4(1-39),
des Pro36 [Met(O)14, Asp28] Exendin-4(1-39),
des Pro36 [Met(O)14, IsoAsp28] Exendin-4(1-39),
des Pro36 [Trp(O2)25, Asp28] Exendin-4(1-39),
des Pro36 [Trp(O2)25, IsoAsp28] Exendin-4(1-39),
des Pro36 [Met(O)14 Trp(O2)25, Asp28] Exendin-4(1-39),
des Pro36 [Met(O)14 Trp(O2)25, IsoAsp28] Exendin-4(1-39); or
des Pro36 [Asp28] Exendin-4(1-39),
des Pro36 [IsoAsp28] Exendin-4(1-39),
des Pro36 [Met(O)14, Asp28] Exendin-4(1-39),
des Pro36 [Met(O)14, IsoAsp28] Exendin-4(1-39),
des Pro36 [Trp(O2)25, Asp28] Exendin-4(1-39),
des Pro36 [Trp(O2)25, IsoAsp28] Exendin-4(1-39),
des Pro36 [Met(O)14 Trp(O2)25, Asp28] Exendin-4(1-39),
des Pro36 [Met(O)14 Trp(O2)25, IsoAsp28] Exendin-4(1-39), wherein the group -Lys6-NH2 may be bound to the C-terminus of the Exendin-4 derivative;

or an Exendin-4 derivative of the sequence
H-(Lys)6-des Pro36 [Asp28] Exendin-4(1-39)-Lys6-NH2,
des Asp28 Pro36, Pro37, Pro38Exendin-4(1-39)-NH2,
H-(Lys)6-des Pro36, Pro38 [Asp28] Exendin-4(1-39)-NH2,
H-Asn-(Glu)5des Pro36, Pro37, Pro38 [Asp28] Exendin-4(1-39)-NH2,
des Pro36, Pro37, Pro38 [Asp28] Exendin-4(1-39)-(Lys)6-NH2,
H-(Lys)6-des Pro36, Pro37, Pro38 [Asp28] Exendin-4(1-39)-(Lys)6-NH2,
H-Asn-(Glu)5-des Pro36, Pro37, Pro38 [Asp28] Exendin-4(1-39)-(Lys)6-NH2,
H-(Lys)6-des Pro36 [Trp(O2)25, Asp28] Exendin-4(1-39)-Lys6-NH2,
H-des Asp28 Pro36, Pro37, Pro38 [Trp(O2)25] Exendin-4(1-39)-NH2,
H-(Lys)6-des Pro36, Pro37, Pro38 [Trp(O2)25, Asp28] Exendin-4(1-39)-NH2,
H-Asn-(Glu)5-des Pro36, Pro37, Pro38 [Trp(O2)25, Asp28] Exendin-4(1-39)-NH2,
des Pro36, Pro37, Pro38 [Trp(O2)25, Asp28] Exendin-4(1-39)-(Lys)6-NH2,
H-(Lys)6-des Pro36, Pro37, Pro38 [Trp(O2)25, Asp28] Exendin-4(1-39)-(Lys)6-NH2,
H-Asn-(Glu)5-des Pro36, Pro37, Pro38 [Trp(O2)25, Asp28] Exendin-4(1-39)-(Lys)6-NH2,
H-(Lys)6-des Pro36 [Met(O)14, Asp28] Exendin-4(1-39)-Lys6-NH2,
des Met(O)14 Asp28 Pro36, Pro37, Pro38 Exendin-4(1-39)-NH2,
H-(Lys)6-desPro36, Pro37, Pro38 [Met(O)14, Asp28] Exendin-4(1-39)-NH2,
H-Asn-(Glu)5-des Pro36, Pro37, Pro38 [Met(O)14, Asp28] Exendin-4(1-39)-NH2,
des Pro36, Pro37, Pro38 [Met(O)14, Asp28] Exendin-4(1-39)-(Lys)6-NH2,
H-(Lys)6-des Pro36, Pro37, Pro38 [Met(O)14, Asp28] Exendin-4(1-39)-(Lys)6-NH2,
H-Asn-(Glu)5 des Pro36, Pro37, Pro38 [Met(O)14, Asp28] Exendin-4(1-39)-(Lys)6-NH2,
H-Lys6-des Pro36 [Met(O)14, Trp(O2)25, Asp28] Exendin-4(1-39)-Lys6-NH2,
H-des Asp28 Pro36, Pro37, Pro38 [Met(O)14, Trp(O2)25] Exendin-4(1-39)-NH2,
H-(Lys)6-des Pro36, Pro37, Pro38 [Met(O)14, Asp28] Exendin-4(1-39)-NH2,
H-Asn-(Glu)5-des Pro36, Pro37, Pro38 [Met(O)14, Trp(O2)25, Asp28] Exendin-4(1-39)-NH2,
des Pro36, Pro37, Pro38 [Met(O)14, Trp(O2)25, Asp28] Exendin-4(1-39)-(Lys)6-NH2,
H-(Lys)6-des Pro36, Pro37, Pro38 [Met(O)14, Trp(O2)25, Asp28] Exendin-4(S1-39)-(Lys)6-NH2,
H-Asn-(Glu)5-des Pro36, Pro37, Pro38 [Met(O)14, Trp(O2)25, Asp28] Exendin-4(1-39)-(Lys)6-NH2;
   or a pharmaceutically acceptable salt or solvate of any one of the afore-mentioned Exedin-4 derivative.

Hormones are for example hypophysis hormones or hypothalamus hormones or regulatory active peptides and their antagonists as listed in Rote Liste, ed. 2008, Chapter 50, such as Gonadotropine (Follitropin, Lutropin, Choriongonadotropin, Menotropin), Somatropine (Somatropin), Desmopressin, Terlipressin, Gonadorelin, Triptorelin, Leuprorelin, Buserelin, Nafarelin, Goserelin.

A polysaccharide is for example a glucosaminoglycane, a hyaluronic acid, a heparin, a low molecular weight heparin or an ultra low molecular weight heparin or a derivative thereof, or a sulphated, e.g. a poly-sulphated form of the above-mentioned polysaccharides, and/or a pharmaceutically acceptable salt thereof. An example of a pharmaceutically acceptable salt of a poly-sulphated low molecular weight heparin is enoxaparin sodium.

Pharmaceutically acceptable salts are for example acid addition salts and basic salts. Acid addition salts are e.g. HCl or HBr salts. Basic salts are e.g. salts having a cation selected from alkali or alkaline, e.g. Na+, or K+, or Ca2+, or an ammonium ion N+(R1)(R2)(R3)(R4), wherein R1 to R4 independently of each other mean: hydrogen, an optionally substituted C1 C6-alkyl group, an optionally substituted C2-C6-alkenyl group, an optionally substituted C6-C10-aryl group, or an optionally substituted C6-C10-heteroaryl group. Further examples of pharmaceutically acceptable salts are described in “Remington's Pharmaceutical Sciences” 17. ed. Alfonso R. Gennaro (Ed.), Mark Publishing Company, Easton, Pa., U.S.A., 1985 and in Encyclopedia of Pharmaceutical Technology.

Pharmaceutically acceptable solvates are for example hydrates.

For example, with respect to insulin, a patient suffering from diabetes may require a certain amount of insulin to either be injected via a pen type injection device like a pen type injection syringe or infused via a pump. With respect to certain known reusable pen type medication or drug delivery devices, a patient loads a reservoir, for example a cartridge, containing the insulin into a proximal end of a reservoir housing, for example a cartridge housing. After this cartridge assembly has been correctly loaded, the user may then select a dose of a medicament or may be called upon to select a dose of medicament. The dose selected by the user may be a fixed or variable dose. Accordingly, the delivery device may be a fixed dose or variable dose device. Concerning a variable dose and a respective device, the user may vary the amount of medicament being expelled out of the device. Moreover, the reservoir or cartridge may contain one dose only or multiple doses. Preferably, multiple doses may be dosed from the cartridge assembly. Where the drug delivery device comprises a reusable device, once the cartridge assembly is empty or the medication or drug contained therein has exceeded its date of expiry, the cartridge housing may be disconnected from the drug delivery device and the empty or expired cartridge may be removed and replaced with a new cartridge. Most suppliers of such cartridges recommend that the user disposes of the empty cartridges properly. Where the drug delivery device comprises a disposable device, once the cartridge assembly is empty, the user is recommended to dispose of the entire device.

Certain drug delivery device users may require more than one drug delivery device for their particular drug regimen. As just one example, some patients suffering from diabetes may need to administer a certain dose of a first medicament and then administer a different dose of a second medicament. As such, such a user would require at least two drug delivery devices, especially two pen type devices. For example, a first pen device may contain a long acting insulin and the second or alternative pen device may contain a different type of insulin, such as a short acting insulin. As the first and second pens may be similar in style and function, there may be the potential for the user to accidentally use the wrong pen type device for a particular administration such that the problem could arise that the user applies the wrong medicament. This could represent a serious hazard if the effects of the medicament injected by mistake are significantly different to the effects of the intended medicament (e.g., fast acting insulin versus slow acting insulin or high strength insulin versus low strength insulin).

There may be, therefore, a general need to provide a means or mechanism that provides some type of indication to the user so as to prevent unwanted cross use of drug delivery devices, such as the unwanted cross use of at least two types of pen type devices. There is also, therefore, a desire to reduce the risk of dispensing an incorrect medicament (or the wrong concentration of the medicament) from such a drug delivery device and enable a user to correctly identify the medicament contained within the drug delivery device. Identifying an incorrect medicament is quite important, since the administration of a potentially incorrect dose of a medicament such as a short acting insulin in lieu of a long acting insulin could result in injury or even death.

The general problem to be solved by this disclosure is to provide a cap for use with a drug delivery device and a drug delivery device where security against unintended use of a drug delivery device may be improved.

### SUMMARY

A user may have more than one drug delivery device, e.g. an injector pen, in their possession, and there may be the potential for them to accidentally use the wrong one. The problem could arise that the user applies the medicament of the wrong device. This could represent a serious hazard if the effects of the drug injected are significantly different to the effects of the intended medication (e.g., fast acting insulin versus slow acting insulin). If all other differentiation clues are missed (e.g., label, pen shape, color, tactile features, etc.), the feel of a cap during removal and replacement onto a drug delivery device may alert the user that they are using the wrong device.

For these purposes, a coded cap for use with a drug delivery device as well as a medication delivery device comprising such a cap may be disclosed. The fit and feel of the cap as the cap is placed onto the drug delivery device and as it is removed from the device may vary across a family of different drug delivery devices. The cap may include one or more first coding features. One example of such first coding features are corresponding protrusions, corresponding recesses, or a combination of the two. The first coding features may also be configured to provide tactile and/or audible feedback to a user to indicate whether the correct drug delivery device has been used. These features can aid in the differentiation between two similar drug delivery devices.

According to an exemplary arrangement, a coded cap for use with a drug delivery device may be provided, wherein the at least one first coding feature may be located on an inner surface of the cap, the at least one first coding feature being configured to interact with at least one second coding feature located on the drug delivery device. When the first and second coding features interact, feedback may be provided to a user. The feedback may include tactile and/or audible feedback.

In a specific embodiment, a cap for use with a drug delivery device is disclosed, the cap comprising: at least one first coding feature, the at least one first coding feature configured to interact with at least one second coding feature of the drug delivery device, wherein the at least one first coding feature is configured such that feedback being characteristic of a specific feature of the drug delivery device is provided, for example to a user, when the first and second coding features interact.

The at least one first coding feature may be configured such that a characteristic time profile and/or a characteristic force intensity profile are provided when the first and second coding features interact.

The provided feedback which may include tactile and/or audible feedback may indicate to a user whether the correct drug delivery device has been used. The cap may be configured such that a characteristic feature of a corresponding device may be coded via the feedback of the first coding features of the cap.

Moreover, a set comprising at least two caps may be provided. Each of the two caps has a first coding feature. The first coding feature of the one cap is configured to provide a first characteristic feedback during interaction with a first device and the other cap is configured to provide a second characteristic feedback during interaction with a second device, the first and second characteristic feedbacks being distinct to each other. The user can, therefore, differentiate between the two feedbacks which indicate different characteristic features of corresponding devices.

These aspects may help for unambiguous use with an associated reservoir so as to prevent unwanted or unintended reservoir cross use and can aid in the differentiation between two similar drug delivery devices. Interaction of the cap with the drug delivery device and consequently interaction of first and second coding features may be established by detachably securing the cap to, for example, the reservoir, for example a cartridge, or the reservoir housing, for example a cartridge holder, or another part of the drug delivery device. Thereby, parts of the device may be covered and protected via the cap.

According to one embodiment, the at least one first coding feature comprises or includes a first protrusion. The first protrusion may constitute a simple but effective mechanical feature which may enable interaction with a second coding feature of a drug delivery device. As an example, the first protrusion is round. But it is also conceivable that the first protrusion may be of any corresponding or suitable shape or combination of shapes for interacting with the second coding feature of a drug delivery device. Thus, in an alternative embodiment, the first protrusion comprises or includes a ramp, especially an angled ramp, i.e. a ramp with linear slope or the like. Moreover, the shape may be designed such that any characteristic kind of audible or tactile feedback may be achieved.

In another embodiment, the at least one first coding feature comprises a plurality, for example at least two first protrusions. With more than one first protrusion, more detailed feedback, for example a time sequence of several single feedbacks, may be achieved. The at least two first protrusions may be provide any suitable shape or combination of shapes as explained above.

The plurality of first protrusions may be located adjacent to one another. With this configuration, a specific pattern of audible or tactile feedback may be achieved. During interaction of the first protrusions with the second coding feature of the drug delivery device, each respective first protrusion may interact with the second coding feature, generating for example a sequence of several audible or tactile “clicks”. In another arrangement, a drug delivery device may be provided. The drug delivery device may have a cartridge containing a medication or drug, a cartridge holder secured to the cartridge, and a cap having an inner surface. The cap may be configured to attach to the cartridge holder. The cap may include at least one first coding feature located on the inner surface configured to mate with at least one second coding feature located on the cartridge holder. The at least one second coding feature may also be located on the cartridge or on another part of the device.

When the first and second coding features interact, feedback may be provided to a user. The feedback may include tactile and/or audible feedback.

In a specific embodiment, the drug delivery device comprises: a cartridge holder suitable to secure a cartridge to the device, a cap according to the type mentioned above configured to attach to the cartridge holder, at least one second coding feature, the at least one first coding feature of the cap configured to interact with the at least one second coding feature, wherein the first and the second coding features are configured such that characteristic feedback being characteristic for a specific feature of the drug delivery device is enabled to be provided to a user when the first and second coding features interact.

The at least one second coding feature may be configured such that a characteristic time profile and/or a characteristic force intensity profile are enabled to be provided.

In one embodiment, the at least one second coding feature comprises or includes a second protrusion. The second protrusion may be round, may comprise a ramp or may be of any corresponding or suitable shape or combination of shapes for interacting with the first coding feature of the cap.

It is also conceivable that the second coding feature comprises or includes a plurality of second protrusions, for example at least two second protrusions. The one or more second protrusions may constitute a simple but effective mechanical feature which may enable interaction with the first coding feature located on the cap of the device.

In one embodiment, the at least two second protrusions may be located adjacent to one another. With this configuration, a specific pattern of audible or tactile feedback may be achieved. During interaction of the second protrusions with the first coding feature of the cap, each respective second protrusion may interact with the first coding feature, generating for example a sequence of several audible or tactile “clicks”.

According to one embodiment, the device is configured such that the enabled feedback comprises at least one of tactile or audible feedback.

Moreover, a set comprising at least two drug delivery devices may be provided. Each of the two devices comprises at least one second coding feature and a cap comprising at least one first coding feature. The first coding feature of the one cap is configured to provide a first characteristic feedback during interaction with the second coding feature of the corresponding device and the other cap is configured to provide a second characteristic feedback during interaction with the second coding feature of the corresponding device, the first and second characteristic feedbacks being distinct to each other. The user can, therefore, differentiate between the two feedbacks which indicate different characteristic features of the corresponding devices.

The scope of the disclosure is defined by the content of the claims. The disclosure is not limited to specific embodiments but comprises any combination of elements of different embodiments. Moreover, the disclosure comprises any combination of claims and any combination of features disclosed by the claims.

The advantages of various aspects of the present disclosure will become apparent to those of ordinary skill in the art by reading the following detailed description, with appropriate reference to the accompanying drawings.

### BRIEF DESCRIPTION OF THE DRAWINGS

Exemplary embodiments are described herein with reference to the drawings, in which:

FIG. 1 illustrates an exemplary pen type drug delivery device;

FIG. 2 illustrates one embodiment of a drug delivery device and cap having corresponding coding features;

FIG. 3 illustrates a close-up view of the coding features shown in FIG. 2;

FIG. 4 illustrates another embodiment of the coding features;

FIG. 5 illustrates yet another embodiment of the coding features;

FIG. 6 illustrates yet another embodiment of the coding features;

FIG. 7 illustrates yet another embodiment of the coding features; and

FIG. 8 illustrates yet another embodiment of the coding features.

### DETAILED DESCRIPTION

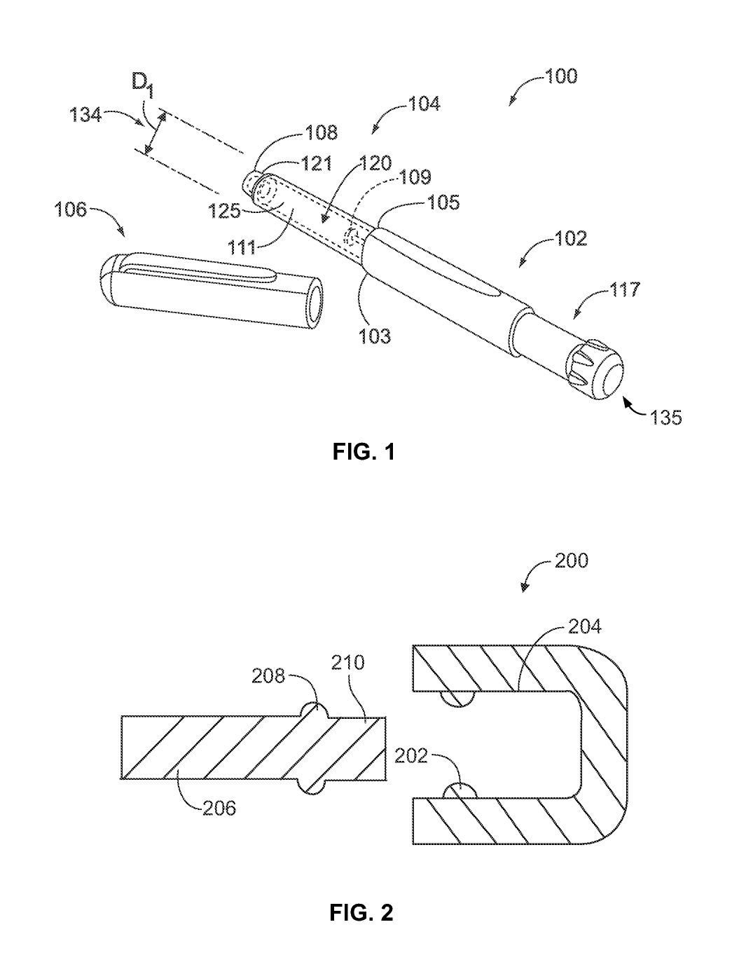

Referring to FIG. 1, there is shown a drug delivery device 100 in the form of a pen type injection device, for example a pen type syringe. The drug delivery device 100 comprises a dose setting mechanism 102, a cartridge holder 104, and a removable cap 106. A cartridge 120 is contained within the cartridge holder 104. The cap 106 may be used to protect the distal end of the drug delivery device 100. In addition, the cap 106 may be provided with a clip so that when the cap 106 is mounted onto the device, the pen can fit in a user's shirt pocket, much like a conventional fountain pen.

A proximal end 105 of the cartridge holder 104 and a distal end 103 of the dose setting mechanism 102 are removably secured together. The dose setting mechanism 102 may comprise a piston rod 109. The piston rod 109 may be a threaded piston rod that rotates when a dose is injected. In particular, the threaded piston rod is helically moved in distal direction of the device 100 for expelling a predetermined amount of a drug or medication out of the cartridge 120.

To inject a previously set dose, a double ended needle assembly (not shown) may be attached to a distal end 108 of the cartridge holder 104. Preferably, the distal end 108 of the cartridge holder 104 comprises a thread 121 (or other suitable connecting mechanism such as a snap lock, snap fit, form fit, or bayonet lock mechanism) so that the needle assembly may be removably attached to the distal end of the cartridge holder 104. When the drug delivery device 100 is not in use, the removable cap 106 can be detachably secured to, i.e. releasably retained over the cartridge holder 104. The cap 106 may also be detachably secured to any other part of the device 100, for example directly to the cartridge 120 or to the distal end 103 of the dose setting mechanism 102.

A number of doses of a medicament 125 contained in the cartridge 120 may be dispensed from the cartridge 120. Preferably, the cartridge 120 contains a type of medicament 125 that must be administered often, such as one or more times a day. One such medicament 125 is for example insulin.

The dose setting mechanism 102 comprises a dose setter 117 at the proximal end 135 of the dose setting mechanism 102. In one preferred arrangement, the dose setter 117 is rotated to set a dose but it is also conceivable that the dose setter 117 is axially or helically moved to set a dose. To administer this set dose, the user attaches the needle assembly comprising, for example, a double ended needle on the distal end of the cartridge holder 104. In this manner, the needle assembly pierces a seal of the cartridge 120 and is therefore in liquid communication with the medicament 125. The user pushes on the dose setter 117 to inject the set dose.

In accordance with exemplary embodiments, a cap, such as cap 106, may be coded to a drug delivery device 100, a cartridge 120, or a cartridge holder 104. The coding of the cap 106 means that a characteristic feedback, audible and/or tactile feedback, may be achieved by interaction of the cap 106 with the device 100. The characteristic feedback may code a characteristic feature of the device 100. This may aid to a user to be aware of using the correct device 100. Moreover, given caps 106 may be coded such that they may only be connected with the respective drug delivery device 100, respective cartridge 120 or respective cartridge holder 104. Also given cartridges 120 and cartridge holders 104 may be coded such that they may only be connected with intended drug delivery devices 100 and vice versa. FIG. 2 illustrates a first arrangement of a part of a drug delivery device 206 and a cap 200 which are coded to each other. The arrangement also may include a tactile and/or audible feedback mechanism as explained below. The coded cap 200 is intended for use with a drug delivery device similar to the drug delivery device 100 of FIG. 1. This coded cap 200 may alternatively be connected to a cartridge 120 or a cartridge holder 104 or another part located on or within a drug delivery device 100 according to FIG. 1.

FIG. 2 illustrates a first embodiment of a coded cap 200 for use with a drug delivery device. Such cap 200 may have the configuration of cap 106 according to FIG. 1 for use with the drug delivery device 100 illustrated in FIG. 1. Furthermore, FIG. 2 shows a part of a drug delivery device 206. The part may for example be an outer surface 210 of a cartridge holder 104.

In the arrangement illustrated in FIG. 2, the cap 200 includes at least one first coding feature on an inner surface 204 of the cap 200. The at least one first coding feature may comprise a first protrusion 202, for example. The first protrusion 202 may be round, or alternatively, the first protrusion 202 may be any suitable shape. The first coding feature may comprise a single first protrusion 202, or may include a plurality of first protrusions 202, for example at least two first protrusions such as one protrusion on each side of the inner surface 204, as shown in FIG. 2.

The first protrusion 202 may interact with at least one second coding feature located on the drug delivery device 206. According to one embodiment, the second coding feature is a second protrusion 208. In particular, FIG. 2 shows two second protrusions 208, one on each side of the part of the device 206. In other arrangements, the device 206 may include any number of protrusions 208. The second protrusions 208 may be symmetrically or non-symmetrically provided along the outer surface 210 of the device 206. It should be understood that the second coding feature, i.e. the second protrusions 208, may be located on any of the drug delivery device 100, the cartridge holder 104, or the cartridge 120 according to FIG. 1, depending upon the type and structure of the drug delivery device 100. The second protrusion 208 may be round, or alternatively, the second protrusion 208 may be any suitable shape to interact with the first protrusion 202.

Furthermore, the interaction of the first and second coding features, i.e. first and second protrusions 202, 208 may create a tactile feedback mechanism. Such tactile feedback mechanism may be a resistance that can be felt by the user. The resistance occurs as the user removes or replaces the cap 200 from or to the drug delivery device 206. If the resistance is felt, the user will know that they are using the correct drug delivery device. As another example, a tight or loose fitting of the cap 200 may indicate to a user that the correct delivery device 206 has been used. As still other examples, a vibration or any changes in the amount of removal force could be implemented as the tactile feedback mechanism.

An audible feedback mechanism may be present, either alone or in combination with the tactile feedback mechanism given by the first and second coding features, i.e. the first and second protrusions 202 and 208. For example, upon interaction of the first and second coding features, a clicking or snapping sound may be generated. If the correct clicking or snapping sound is heard, this may help the user to confirm that they are indeed using the correct drug delivery device, and hence, the correct medicament 125. Alternatively, if the incorrect clicking or snapping sound is heard, this may help the user to confirm that they are indeed using an incorrect drug delivery device, and hence, the incorrect medicament 125. It should be understood that the audible feedback mechanism may be any type of audible sound, such as clicking, ratchet noise or the like.

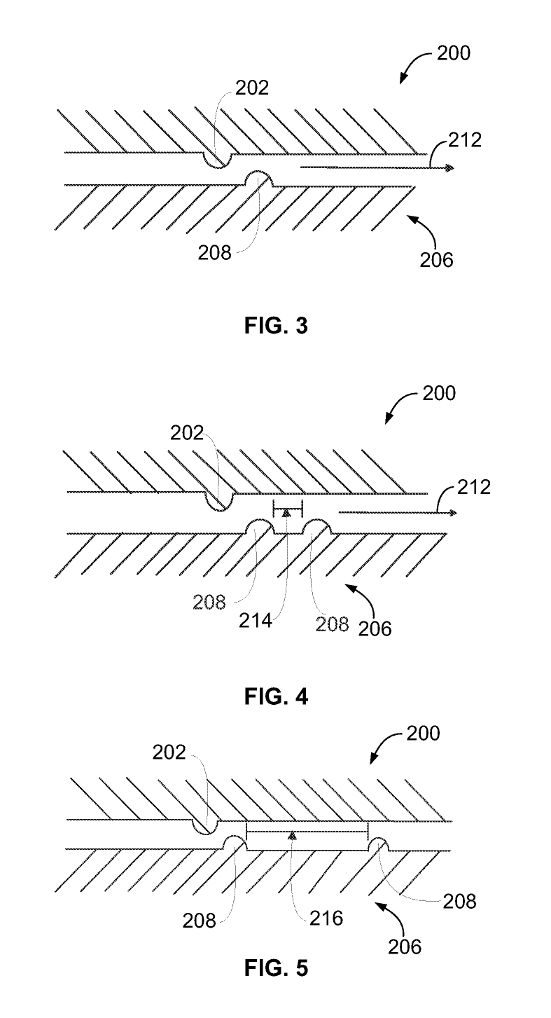

In operation, as shown in FIG. 3, when a user needs to administer a dose of a medicament 125, the user removes the cap 200 from the part of the drug delivery device 206, i.e. cartridge holder, or cartridge, in a direction 212, i.e. cap 200 is moved in direction 212 to be detached from the part of the device 206. As the cap 200 is pulled off of the part of the device 206, the first protrusion 202 slides past the second protrusion 208, creating feedback that is experienced by the user holding both the device 206 and the cap 200. If the user experiences this feedback, then the user will gain confidence that they will be administering the appropriate medicament 125. This feedback may also be experienced when the cap 200 is replaced or put back onto the device in a direction opposite to direction 212.

In one arrangement, a specific configuration of the first and second coding features and/or feedback mechanism may indicate that a drug delivery device 206 contains a specific medication or drug. For example, if resistance is felt as the cap 200 is removed, it may indicate via this tactile feedback to a user that the cartridge 120 contains a slow acting insulin.

As another example of an audible feedback, if a first clicking sound is heard as the cap 200 is removed, this first clicking sound may indicate to a user that the cartridge 120 contains a fast acting insulin. Alternatively, if a second or different clicking sound is heard as the cap 200 is removed, that may indicate to a user that the cartridge 120 does not contain a fast acting insulin but rather may contain a different type of medicament 125, such as a slow acting insulin.

One advantage of the disclosed system of a coded cap 200 in combination with a respective device 206 may be that the user can identify whether the correct medicament 125 is being administered early on in the overall dose setting and dose injection process. This tends to prevent the accidental administration of the wrong type of medication or drug by a patient. Moreover, the disclosed system of a coded cap 200 and a respective device 206 provides an additional signal to the patient if the patient has missed other signals that they may be administering the wrong medicament 125 from the wrong drug delivery device, such as the shape or color of the pen or perhaps what a manufacturer provides on a label attached to the device.

In other arrangements, described in more detail below, the cap 200 may include any number of protrusions in various configurations. In an alternative arrangement, one or more recesses could be provided to cooperate with one or more protrusions, either on the cap 200 or the surface 210 of the drug delivery device 206.

FIGS. 4-8 show different exemplary arrangements of the first and second coding features 208. Any of the features described herein may be present, either alone or in combination. As shown in FIGS. 4 and 5, the spacing between multiple second protrusions 208 on the device 206 may be varied to create different amounts of feedback for the user. In FIG. 4, the second protrusions 208 are spaced substantially adjacent to one another at a distance 214, thereby causing the user to experience the feedback within a short timeframe. Alternatively, in FIG. 5, the second protrusions 208 are spaced apart and substantially non-adjacent to one another at a distance 216, which is larger than distance 214 according to FIG. 4, thereby causing the user to experience the feedback within a longer timeframe. Depending on varying distances 214 and 216, characterizing time profiles or sequences may be achieved, each profile or sequence coding a respective relationship between a cap 200 and its corresponding device 206.

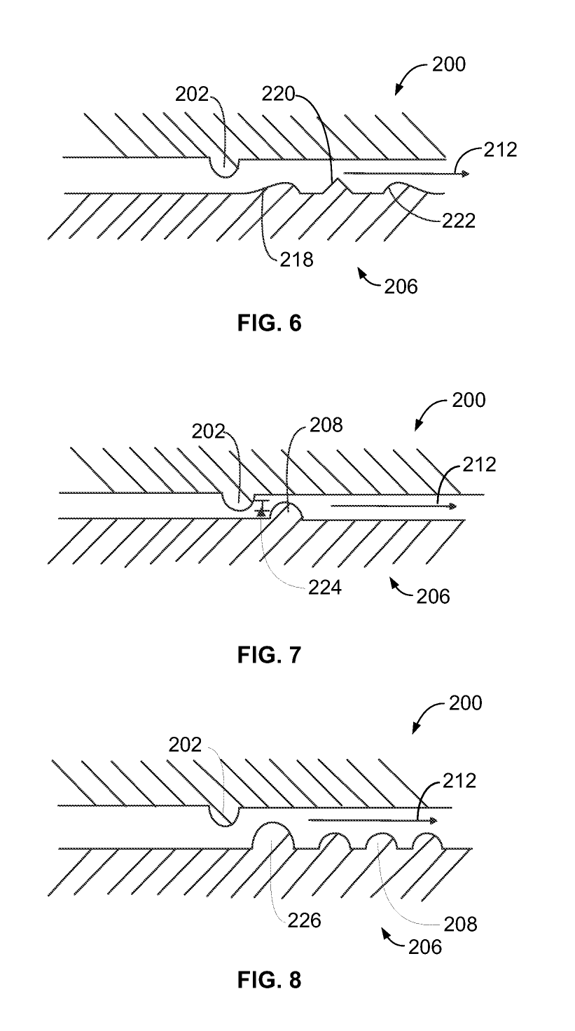

Referring to FIG. 6, the geometry of the protrusions 202 and/or 208 may comprise various shapes and angles. For example, the second protrusions 208 on the device 206 may be of any suitable shape, and may include a variety of contact faces for interacting with the first protrusion 202 on the cap 200. Examples of such contact faces, as shown in FIG. 6, include a slight ramp 218, two ramps 220, or a steep ramp 222. The steepness of the ramp 218, 220 or 222 will impact the amount of force needed to pull the cap 200 off of and push the cap 200 onto the device 206. This amount of force may indicate to a user that they are using the correct device, or alternatively what type of medication or drug is contained in the device. Depending on varying shapes and angles of protrusions 208 and/or 202, different force intensity profiles or sequences can be achieved, each profile or sequence coding a characteristic feature of a cap 200 and its corresponding device 206.

The interference of the protrusions may also be varied. As shown in FIG. 7, the protrusions 202, 208 may have a large overlapping interference 224. Alternatively, as shown in FIG. 3, the protrusions may have a small overlapping interference. The amount of interference may impact the amount of force needed to pull the cap 200 off and push the cap 200 onto the device 206. This amount of force may indicate to a user that they are using the correct device 206, or alternatively what type of medication or drug is contained in the device 206. The size of the interference could also affect an audible signal provided to the user.

In yet another arrangement, the size of the protrusions may vary. For example, as shown in FIG. 8, one second protrusion 226 in a series of second protrusions 208 on the device 206 is larger than the rest of the second protrusions 208. The momentum will cause the cap 200 to keep moving in direction 212 after the initial resistance of protrusion 226 is overcome.

It is conceivable that the respective variations in the shape, angle or dimension of the respective protrusions 202 and 208 according to the embodiments of FIGS. 3 to 8 may optionally be combined with each other to achieve tactile feedback adapted to time, force and resistance of the interaction between cap 200 and device 206. Also audible feedback may be adapted to any desired sound depending on the shape, angle, dimension or form of the respective protrusions 202 and 208.

In yet another arrangement, the materials used or surface finish may vary. For example, a soft rubber type material could be used to give a different resistance feel with respect to a hard material such as polycarbonate.

Although aimed primarily at the insulin market, the disclosed coded cap 106 or 200 in combination with a coded cartridge 120, coded cartridge holder 104 or other coded part of a drug delivery device 100 or 206 may apply to other medicaments or drugs. The disclosure may apply to various devices, including the following examples:
a. An injector pen with a cartridge 120 (e.g. 3 ml cylindrical glass cartridge) and a separate cartridge holder 104.
b. An injector pen with a cartridge 120 (e.g. 3 ml cylindrical glass cartridge) non-removably retained in a cartridge holder 104, so that the cartridge holder 104 will be disposed of with the primary pack.
c. An injector pen where the primary pack attaches directly to the pen, e.g. an injection-moulded polymer cartridge 120.
d. Any drug delivery device, with any type of primary pack, e.g. inhaler or pouch that includes a cap 200.

The disclosed coding system may result in a number of advantages. For example, the disclosed coded cap and device arrangements assist a user to distinguish between different pens containing a different medicament 125, thereby helping to ensure that the user administers a dose from a correct delivery device. The disclosed coded cap 200 may also be used in combination with any other coding system, such as a coding system that prevents a user from completing one or more of the following actions: fully inserting the cartridge 120 assembly into an incorrect cartridge holder 104 or attaching the cartridge 120 and/or cartridge holder 104 onto an incorrect dose setting mechanism 102.

The disclosed coded cap 106, 200 as well as the corresponding coded device 100, 206 also may result in a low cost coding mechanism since the proposed caps 200, cartridges 120, cartridge holders 104, and drug delivery devices 100, 206 may not require a large number of parts and can be manufactured in a cost effective manner. For example, the disclosed coded cap 200 as well as the corresponding device 100, 206 result in a low cost coding mechanism since the feedback effect or function can be achieved with no additional components to those normally present in a drug delivery device 100, 206. Moreover, there are quite a large number of different cartridge coding configurations between the cap 200, cartridge 120, cartridge holder 104, and drug delivery device 100, 206 that may be used. Consequently, with the disclosed coding schemes, a large number of medicaments 125 can be distinguished from one another.

Exemplary embodiments of the present disclosure have been described. Those skilled in the art will understand, however, that changes and modifications may be made to these arrangements without departing from the true scope and spirit of the present disclosure, which is defined by the claims.

1-13. (canceled)

14. A cap for use with a drug delivery device, the cap being configured to be detachably secured to the drug delivery device in order to cover and protect at least a part of the drug delivery device and comprising:
at least one first coding feature, the at least one first coding feature configured to interact with at least one second coding feature of the drug delivery device;
wherein the at least one first coding feature is configured such that tactile and/or audible feedback being characteristic of a specific feature of the drug delivery device is provided to a user when the first and second coding features interact,
wherein the at least one first coding feature comprises at least two first protrusions which are located adjacent to one another, wherein the geometry of the first protrusions comprises different shapes.

15. The cap of claim 14 wherein the at least one first coding feature is configured such that a characteristic time profile and/or a characteristic force intensity profile are provided when the first and second coding features interact.

16. The cap of claim 14 wherein at least one of the two first protrusions is round.

17. The cap of claim 14 wherein at least one of the two first protrusions comprises a ramp.

18. A drug delivery device comprising:
a cartridge holder suitable to secure a cartridge to the device;
a cap according to claim 14 configured to be attached to the cartridge holder;
at least one second coding feature;
the at least one first coding feature of the cap configured to interact with the at least one second coding feature;
wherein the first and the second coding features are configured such that tactile and/or audible feedback being characteristic of a specific feature of the drug delivery device is provided to a user when the first and second coding features interact.

19. The drug delivery device of claim 18 wherein the at least one second coding feature is located on the cartridge holder.

20. The drug delivery device of claim 18 wherein the at least one second coding feature is located on the cartridge.

21. The drug delivery device of claim 18 wherein the at least one second coding feature is configured such that a characteristic time profile and/or a characteristic force intensity profile are provided when the first and second coding features interact.

22. The drug delivery device of claim 18 wherein the at least one second coding feature comprises a second protrusion.

23. The drug delivery device of claim 22 wherein the second protrusion is round.

24. The drug delivery device of claim 22 wherein the second protrusion comprises a ramp.

25. The drug delivery device of claim 22 wherein the at least one second coding feature comprises at least two second protrusions.

26. The drug delivery device of claim 25 wherein the at least two second protrusions are located adjacent to one another.
